(19) United States
(12) Patent Application Publication
(10) Pub. No.: US 2026/0168823 A1
(43) Pub. Date: Jun. 18, 2026

(54) REFLECTIVE PHOTOELECTRIC ENCODER

(71) Applicant: SUTENG INNOVATION TECHNOLOGY CO., LTD., Shenzhen (CN)

(72) Inventor: Peng JIANG, Shenzhen (CN)

(73) Assignee: SUTENG INNOVATION TECHNOLOGY CO., LTD., Shenzhen (CN)

(21) Appl. No.: 19/415,761

(22) Filed: Dec. 10, 2025

(30) Foreign Application Priority Data
Dec. 13, 2024 (CN) 202411847996.X

(51) Int. Cl. G01D 5/347; G01S 7/481

(52) U.S. Cl. CPC G01D 5/3473; G01D 5/34715; G01S 7/481

(57) ABSTRACT

A reflective photoelectric encoder includes a reflective photoelectric switch and a code disk. A surface of the code disk includes a first zone and a second zone. The first zone includes alternating first reflective areas and first non-reflective areas. A width of each first reflective area along a circumferential direction of the code disk is equal to a width of each first non-reflective area. The second zone comprises one second reflective area and one second non-reflective area, adjacent to each other, their widths along the circumferential direction being equal. The width of the second reflective area is twice the width of a first reflective area.

### CROSS-REFERENCE TO RELATED APPLICATION

The present application claims the benefit of priority to Chinese Patent Application No. 202411847996.X, filed on Dec. 13, 2024, which is hereby incorporated by reference in its entirety.

### TECHNICAL FIELD

The present application relates to the field of LiDAR technology, and in particular to a reflective photoelectric encoder and a LiDAR.

### BACKGROUND

Mechanical LiDAR utilizes a motor to rotate the optical-mechanical structure 360°, enabling all-around detection of the surrounding environment. In order to locate the rotation angle of the LiDAR in real time, a photoelectric encoder is usually employed for angle measurement and control, thereby determining the emission and reception direction of the laser and calculating the distance and angle of the target objects.

With technological advancements, reflective photoelectric encoders have gradually replaced traditional transmissive photoelectric encoders, effectively reducing the size of mechanical LiDAR. A reflective photoelectric encoder utilizes a code disk and a reflective photoelectric switch to detect and output the position of the mechanical LiDAR motor. In related technologies, the surface structure of conventional code disks and the placement of reflective photoelectric switches result in poor consistency and low quality of the encoder output signals. This leads to inaccurate position measurement of the code disk and ineffective control of the motor speed, thereby affecting the scanning accuracy of the LiDAR and the precision of detection range.

### SUMMARY

To address the technical problems existing in related technologies, embodiments of the present application provide a reflective photoelectric encoder. By optimizing the surface structure of the code disk and changing the placement direction of the reflective photoelectric switch relative to the code disk, the uniformity and consistency of the signals are improved, effectively enhancing the quality and reliability of the output signals of the reflective photoelectric encoder, thereby increasing the stability of motor control in LiDAR.

An embodiment of the present application provides a reflective photoelectric encoder, including a reflective photoelectric switch and a code disk.

The surface of the code disk includes a first zone and a second zone. The first zone includes a first reflective area and a first non-reflective area, and the second zone includes a second reflective area and a second non-reflective area. In the first zone, the area between any two adjacent first non-reflective areas is the first reflective area, and the width of the first reflective area along the circumferential direction of the code disk is equal to the width of the first non-reflective area along the circumferential direction of the code disk. The second reflective area and the second non-reflective area are adjacent to each other, and the width of the second reflective area along the circumferential direction of the code disk is equal to the width of the second non-reflective area along the circumferential direction of the code disk. The width of the second reflective area along the circumferential direction of the code disk is twice the width of the first reflective area along the circumferential direction of the code disk. By optimizing the structural parameters of the first zone and the second zone within the same circumference of the code disk, the symmetry and uniformity of the encoder output signals are improved. This scheme also improves the problem of poor output signals consistency caused by the temperature drift of the light-emitting element and photosensitive element in the reflective photoelectric switch, making the amplitudes of the output signals corresponding to the first zone and the second zone closer.

In some embodiments, there are multiple first reflective areas and multiple first non-reflective areas; and there is one second reflective area and one second non-reflective area.

In some embodiments, the reflective photoelectric switch includes a light-emitting element, a photosensitive element, and a detection circuit. The light-emitting element and the photosensitive element are arranged sequentially along the radial direction perpendicular to the code disk. By changing the orientation of the reflective photoelectric switch relative to the code disk, the amplitude of the output signals can be increased, the consistency of the corresponding output signals in the first and second zones can be improved, and the quality of the output signals of the reflective photoelectric encoder can be enhanced.

In some embodiments, the code disk is made of stainless steel, and both the first and second reflective areas are made of mirror-finished stainless steel with a reflectivity exceeding 50% and a Gaussian scattering angle of less than 10°. Because the mirror-finished surfaces of the first and second reflective areas on the code disk resists the accumulation of dust and oil, thereby helping maintain the cleanliness and reflectivity of the code disk. This ensures the accuracy and stability of the encoder output signals.

In some embodiments, the first non-reflective areas and the second non-reflective areas are coated with black metal or ink. They are coated with black metal. The black metal coating on the first and second non-reflective areas of the code disk enhances the absorption or scattering of light, thereby improving the accuracy and stability of the encoder output signals. The black metal coating increases the wear resistance of the first and second non-reflective areas, extending the service life of the code disk.

In some embodiments, the reflective photoelectric switch further includes a housing, within which the light-emitting element, the photosensitive element, and the detection circuit are all housed. The housing is made of glass, ceramic, or aluminum.

In some embodiments, the light-emitting element is a light-emitting diode, and the photosensitive element is a photodiode or a phototransistor.

In some embodiments, the detection circuit includes a zero-crossing comparator for converting the received electrical signals into square wave signals, which are configured to obtain the position of the code disk. By using a zero-crossing comparator in the detection circuit can introduce hysteresis to improve anti-interference capability and reduce false triggering caused by noise.

In some embodiments, the detection circuit includes an analog-to-digital converter for converting the received electrical signals into digital signals. Square wave signals are then extracted from the digital signals through digital signal processing techniques, and these square wave signals are configured to obtain the position of the code disk. By employing an analog-to-digital converter to acquire the electrical signals output by the photosensitive element and subsequently parsing square wave signals via digital signal processing techniques, the flexibility and accuracy of signal processing can be improved. The digital signal processing techniques can perform noise reduction, amplification, and shaping on the acquired signals to improve the stability and reliability of the encoder.

In some embodiments, a LiDAR includes a housing and a reflective photoelectric encoder as described in any of the above embodiments.

The present application discloses a reflective photoelectric encoder. By optimizing the relevant parameters of the first and second zones within the same circumference of the code disk, and by changing the placement orientation of the reflective photoelectric switch relative to the code disk, the symmetry and consistency of the encoder output signals are improved, while the amplitude of the output signals is also increased, thereby enhancing the quality of the reflective photoelectric encoder output signals. By optimizing the material and treatment of the code disk surface, the production costs are reduced, and the amplitudes of the corresponding output electrical signals in the first and second zones are also made very close, resulting in more stable and reliable encoder output signals, thus leading to more stable motor control.

### BRIEF DESCRIPTION OF DRAWINGS

To describe the technical solutions in the embodiments of the present application or the prior art more clearly, the following briefly introduces the accompanying drawings for describing the embodiments or the prior art. Obviously, the drawings in the following description merely represent some embodiments of the present application. A person of ordinary skill in the art may still derive other drawings from these accompanying drawings without creative efforts.

FIG. 1 is a partial structural schematic diagram of a reflective photoelectric encoder according to some embodiments of a comparative example;

FIG. 2 is a schematic diagram of the output signals of a reflective photoelectric encoder according to some embodiments of a comparative example;

FIG. 3 is a schematic diagram of the output signals of a reflective photoelectric encoder according to some embodiments of a comparative example, where the reflective areas of the code disk are made of non-mirror-finished stainless steel material and the non-reflective areas are treated with an electrophoretic process;

FIG. 4 is a schematic diagram of the structure of a reflective photoelectric encoder according to some embodiments of the present application;

FIG. 5 is a schematic diagram of the signals output by the reflective photoelectric switch relative to the code disk at different placement positions in a reflective photoelectric encoder according to some embodiments of the present application; and

FIG. 6 is a schematic diagram of the output signals of a reflective photoelectric encoder according to some embodiments of the present application, where the reflective areas of the code disk are made of mirror-finished stainless steel material, and the non-reflective areas are treated by physical vapor deposition process.

### DETAILED DESCRIPTION

In order to explain the purpose, technical solutions, and advantages of the present application clearer, the following description is provided in further detail below with reference to the accompanying drawings. It should be understood that the embodiments described herein are only some embodiments of the present application, rather than all embodiments. Based on the embodiments of the present application, all other embodiments obtained by ordinary technicians in this field without creative efforts are within the scope of protection of the present application.

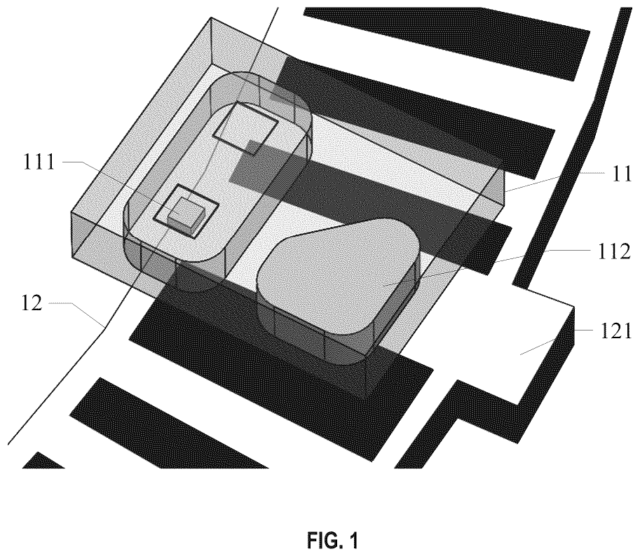

As shown in FIG. 1, in an embodiment, a reflective photoelectric encoder 1 includes a reflective photoelectric switch 11 and a code disk 12. The reflective photoelectric switch 11 is configured not only to emit light but also to receive light. The reflective photoelectric switch 11 includes a light-emitting element 111, a photosensitive element 112, and a detection circuit The light-emitting element 111 and the photosensitive element 112 are on the same side of the code disk 12. The light-emitting element 111 utilizes a light-emitting diode to emit light, and the photosensitive element 112 utilizes a photodiode or a phototransistor to receive light.

In an embodiment, the code disk 12 is a reflective photoelectric code disk. The outer edge of the code disk 12 has a protruding position, which is the zero-position tooth 121. When the code disk 12 rotates, the zero-position tooth 121 serves as the reference zero point for angular positioning of the code disk 12. The surface of the code disk 12 includes a first zone and a second zone. The first zone includes a first reflective area and a first non-reflective area, and the second zone includes a second reflective area and a second non-reflective area. There are multiple first reflective areas and multiple first non-reflective areas, with the area between any two adjacent first non-reflective areas is the first reflective area. There is one second reflective area and one second non-reflective area, and the second reflective area and the second non-reflective area are adjacent to each other. The surface of the zero-position tooth 121 is either the second reflective area or the second non-reflective area. The first and second non-reflective areas are matte reflective surfaces or black reflective surfaces, while the first and second reflective areas are high-gloss reflective surfaces.

In an embodiment, the reflective photoelectric switch 11 is positioned above the surface of the first and second zones of the code disk 12 to detect the positions of the code disk 12 and the motor. The light-emitting element 111 emits light that illuminates the first and second zones on the code disk 12. When the motor drives the code disk 12 to rotate, the first and second reflective zones on the code disk 12 reflect the received light toward to the photosensitive element 112. The absorption or scattering of light by the first and second non-reflective zones results in the photosensitive element 112 receiving less light or no light at all. The photosensitive element 112 converts the received light signals into electrical signals, which are processed by the detection circuit in the reflective photoelectric switch 11 to determine the position of the code disk 12, thereby further determining the position of the motor.

In an embodiment, due to the large number of first reflective and first non-reflective areas in the first zone of the code disk 12, the distribution density of the first reflective and first non-reflective areas in the first zone is high. In this case, the placement of the reflective photoelectric switch 11 relative to the code disk 12 is configured such that the light-emitting element 111 and the photosensitive element 112 in the reflective photoelectric switch 11 are arranged sequentially along the radial direction of the code disk 12. When the distribution density of the first reflective and first non-reflective areas on the code disk 12 in the first zone is high, the photoelectric reflection signal from the second zone in the output signal of the reflective photoelectric switch 11 exhibits increased non-uniformity compared to the photoelectric reflection signal from the first zone. The consistency and stability of the signals output by the reflective photoelectric switch 11 are also poor, meaning that the amplitude of the photoelectric reflection signal corresponding to the second zone differs significantly from that of the first zone. As the light-emitting element 111 and the photosensitive element 112 in the reflective photoelectric switch 11 are affected by temperature and produce temperature drift, the zero-position detection signal output by the reflective photoelectric switch 11 is not constant, resulting in poor signal consistency and stability of the output signals of the reflective photoelectric switch 11, thereby reducing the accuracy and stability of motor control.

In an embodiment, the width ratio of the first reflective area and the first non-reflective area in the first zone, and the width ratio of the second reflective area and the second non-reflective area in the second zone along the circumference of the code disk 12, is typically adjusted to improve the stability and consistency of the output signals of the reflective photoelectric switch 11. That is, the stability and consistency of the photoelectric reflection signals corresponding to the first and second zones within the same circumference. This adjustment scheme results in uneven high and low levels of the electrical signals output by the reflective photoelectric switch 11. That is, the duty cycle of the output signals is not 50%, leading to reduce the accuracy of the output signals, thereby further diminishing the measurement accuracy and resolution of the encoder, and ultimately reducing the precision of motor speed control.

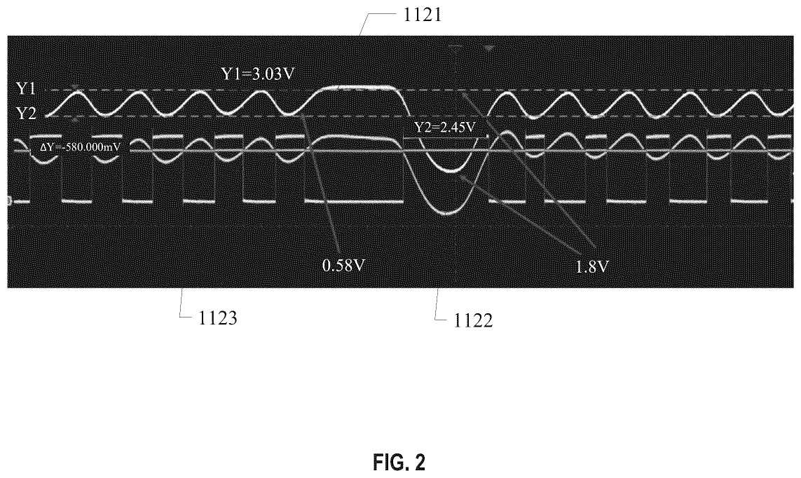

In an embodiment, the signals output by the reflective photoelectric encoder 1 shown in FIG. 1 are illustrated in FIG. 2. Signal 1121 is the electrical signal output by the reflective photoelectric switch 11, signal 1122 is the AC signal after removing the DC signal from signal 1121, and signal 1123 is a square wave signal generated by a zero-crossing comparator. In signal 1121, the peak-to-peak value of the signal corresponding to the first zone on the code disk 12 is 0.58V, and the peak-to-peak value of the signal corresponding to the second zone is 1.8V. It can be seen that the output signal of the second zone increases unevenly compared to the first zone. It can be seen from signal 1123 that the duty cycle of the square wave signal after passing through the zero-crossing comparator is inconsistent, meaning the duty cycle of the output signals corresponding to the first and second zones is not 1:1.

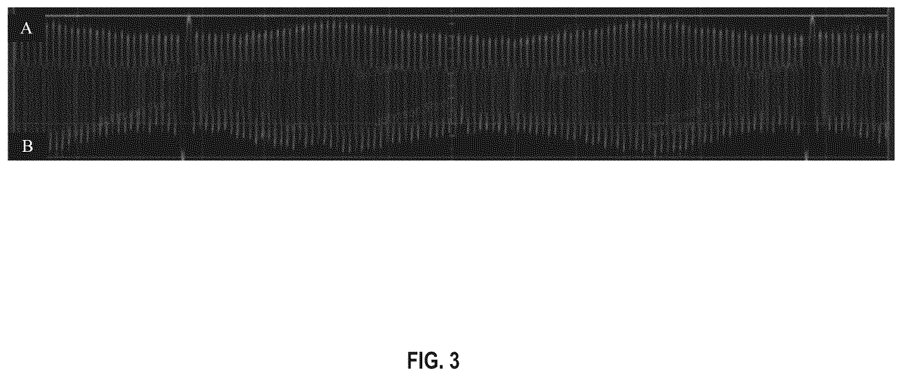

In an embodiment, both the first and second non-reflective areas on the code disk 12 are fabricated using an electrophoretic process. When the first and second non-reflective areas on the code disk 12 are fabricated using an electrophoretic process, the corresponding output signals of the reflective photoelectric switch 11 are shown in FIG. 3. As shown in FIG. 3, because the reflectivity of any two first non-reflective areas on the code disk 12 fabricated by the electrophoretic process is inconsistent, the signal consistency output by the reflective photoelectric switch 11 is poor. That is, the amplitude of output signals at the same position on the code disk 12 is inconsistent according to different rotations of the code disk 12, thereby reducing the reliability and stability of the encoder.

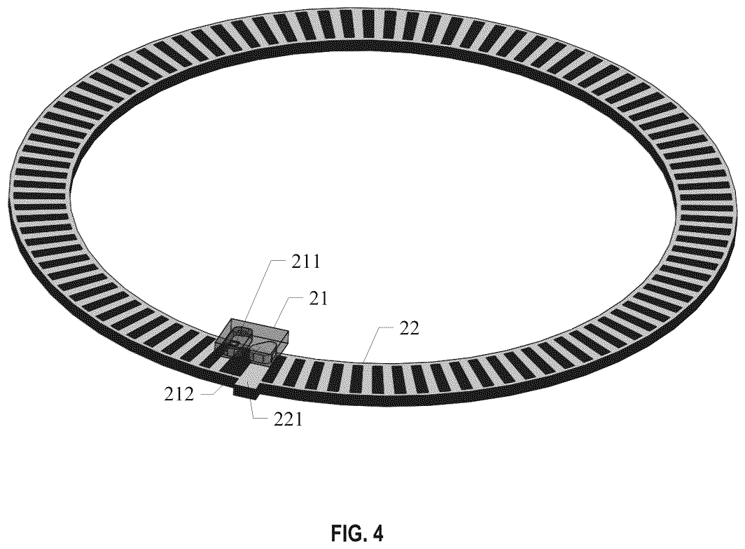

As shown in FIG. 4, an embodiment of the present application provides a reflective photoelectric encoder 2, including a reflective photoelectric switch 21 and a code disk 22. The reflective photoelectric switch 21 is configured not only to emit light but also to receive light. The reflective photoelectric switch 21 includes a light-emitting element 211, a photosensitive element 212, and a detection circuit, and the light-emitting element 211 and the photosensitive element 212 are on the same side of the code disk 22. The light-emitting element 211 utilizes a light-emitting diode to emit light, and the photosensitive element 212 utilizes a photodiode or a phototransistor to receive light.

In an embodiment, the reflective photoelectric switch 21 further includes a housing, within which the light-emitting element 211, the photosensitive element 212, and the detection circuit are all housed. The housing is made of glass, ceramic, or aluminum. The glass possesses excellent optical properties and thermal stability, making it suitable for reflective photoelectric switches requiring clear optical windows, and it can maintain good performance within a certain temperature range. Ceramic not only has good electrical insulation properties, making it suitable for reflective photoelectric switches requiring high insulation resistance, but also its thermal conductivity and heat resistance are superior to many other materials, making it suitable for high-temperature environments. Aluminum has high thermal conductivity, making it suitable for reflective photoelectric switches requiring heat dissipation, and it is also easy to process, form, and cost-effective.

In an embodiment, the code disk 22 is a reflective photoelectric code disk. The outer edge of the code disk 22 has a protruding position, which is the zero-position tooth 221. When the code disk 22 rotates, the zero-position tooth 221 serves as the reference zero point for angular positioning of the code disk 22. The surface of the code disk 22 includes a first zone and a second zone. The first zone includes a first reflective area and a first non-reflective area, and the second zone includes a second reflective area and a second non-reflective area. There are multiple first reflective areas and multiple first non-reflective areas, with the area between any two adjacent first non-reflective areas is the first reflective area. There is one second reflective area and one second non-reflective area, and the second reflective area and the second non-reflective area are adjacent to each other. The surface of the zero-position tooth 221 is either the second reflective area or the second non-reflective area. The outwardly protruding zero-position tooth 221 on the code disk 22 facilitates positioning of the code disk 22 during processing and installation, reducing errors during processing and installation, and improving the overall performance of the code disk. On the other hand, the same circumference of the code disk 22 includes both the first reflective and the first non-reflective areas, as well as the second reflective and the second non-reflective areas. A reflective photoelectric switch 21 can be configured to read the zero position and position of the code disk 22, achieving precise and real-time measurement, improving the reliability of the encoder, and simplifying the structure of the code disk 22, thereby reducing the size of the encoder and facilitating the miniaturization of LiDAR products.

In an embodiment, the width of the first reflective area along the circumference of the code disk 22 and the width of the first non-reflective area along the circumference of the code disk 22 are equal within the same circumference of the code disk 22; the width of the second reflective area along the circumference of the code disk 22 and the width of the second non-reflective area along the circumference of the code disk 22 are equal; and the value of the width of the second reflective area along the circumference of the code disk 22 is twice the value of the width of the first reflective area along the circumference of the code disk 22. By optimizing the structural parameters of the first and second zones within the same circumference of the code disk 22, the symmetry and uniformity of the encoder output signals are improved. This scheme also improves the problem of poor output signals consistency and stability caused by the temperature drift of the light-emitting element 211 and the photosensitive element 212 in the reflective photoelectric switch 21, making the amplitude of the output electrical signals corresponding to the first and second zones closer.

In an embodiment, the width of the second reflective area of the code disk 22 along the circumference of the code disk 22 is greater than 1.5 times the width of the first reflective area in the first zone along the circumference of the code disk 22, and less than 3 times the width of the first reflective area in the first zone along the circumference of the code disk 22. The widths of the first reflective area and the first non-reflective area of the code disk 22 along the circumference of the code disk 22 are equal, and the widths of the second reflective area and the second non-reflective area of the code disk 22 along the circumference of the code disk 22 are also equal. Setting the width of the second reflective area of the code disk 22 within this range avoids the following: on the one hand, if the width of the second reflective area along the circumference of the code disk 22 is too large, the total area of the first zone within the same circumference will decrease, resulting in fewer first reflective and first non-reflective areas in the first zone; or, if the number of first reflective and first non-reflective areas in the first zone remains constant, the distribution density will increase, thereby reducing the detection accuracy and precision of the encoder. On the other hand, it can prevent the detection accuracy of the encoder from being reduced if oil and dust cover the surface of the second reflective area when the width of the second reflective area along the circumference of the code disk 2 is too small.

In an embodiment, a reflective photoelectric switch 21 is disposed above the surface of the code disk 22 containing the first and second zones, for detecting the positions of the code disk 22 and the motor. The light-emitting element 211 in the reflective photoelectric switch 21 emits light that illuminates the first and second zones on the code disk 22; when the motor drives the code disk 22 to rotate, the first and second reflective areas on the code disk 22 reflect the received light to the photosensitive element 212; while the absorption or scattering of light by the first and second non-reflective areas results in the photosensitive element 212 receiving less light or no light at all; the photosensitive element 212 converts the received light signals into electrical signals, which are processed by the detection circuit in the reflective photoelectric switch 21 to determine the position of the code disk 22, thereby further determining the position of the motor.

In an embodiment, the detection circuit in the reflective photoelectric switch 21 includes a zero-crossing comparator for converting the received electrical signals from the photosensitive element 212 into square wave signals to obtain the position of the code disk 22 and the rotational speed of the motor. The position of the code disk 22 includes the rotation direction and angle. By using a zero-crossing comparator in the detection circuit that introduces hysteresis, the system improves anti-interference capability and reduces false triggering caused by noise.

In an embodiment, the detection circuit in the reflective photoelectric switch 21 includes an analog-to-digital converter to convert the received electrical signals from the photosensitive element 212 into digital signals. Then, digital signal processing techniques are configured to extract square wave signals from the digital signals to obtain the position of the code disk 22 and the motor speed. The position of the code disk 22 includes the rotation direction and angle. The use of digital signal processing techniques to extract the square wave signals enhances the flexibility and accuracy of signal processing. The digital signal processing techniques can perform noise reduction, amplification, and shaping on the acquired signal to improve the stability and reliability of the encoder.

In an embodiment, the light-emitting element 211 and the photosensitive element 212 in the reflective photoelectric switch 21 are arranged sequentially along the radial direction perpendicular to the code disk 22. By changing the placement orientation of the reflective photoelectric switch 21 and the code disk 22, the area of the light emitted by the light-emitting element 211 that illuminates the code disk 22 is reduced, decreasing the divergence and offset of the light on the code disk 22, thereby making the light received on the code disk 22 more concentrated. This scheme improves the efficiency of the photosensitive element 212 in collecting the reflected light on the code disk 22, and also reduces the interference from external environmental factors, such as stray light on the photosensitive element 212. This scheme enables the reflective photoelectric switch 21 to more effectively receive the reflected light on the code disk 22, improving the photoelectric conversion efficiency, thereby increasing the amplitude of the encoder output signals, improving signal consistency, and enhancing the quality of the reflective photoelectric encoder output signals.

In an embodiment, the distance between the second reflective area on the code disk 22 and the reflective photoelectric switch 21 is greater than 0.5 times and less than 2 times the period of the first reflective area on the code disk 22. The distance between the second reflective area on the code disk 22 and the reflective photoelectric switch 21 is the distance between the emitting surface of the light-emitting element 211 and the second reflective area, or the distance between the receiving surface of the photosensitive element 212 and the second reflective area. The emitting surface of the light-emitting element 211 and the receiving surface of the photosensitive element 212 are parallel to the second reflective area. Setting the distance between the second reflective area in the second zone of the code disk 22 and the reflective photoelectric switch 21 within this range serves two purposes. On the one hand, it avoids excessively large distances between the reflective photoelectric switch 21 and the second reflective area in the second zone of the code disk 22, which could lead to bearing instability and increase the size of the LiDAR. On the other hand, it avoids the situation where the distance between the reflective photoelectric switch 21 and the second reflective area in the second zone of the code disk 22 is too small, resulting in excessively strong reflected light energy on the bright surface of the code disk 22, exceeding the acceptable range of the photosensitive element 212. Setting the distance between the second reflective area in the second zone of the code disk 22 and the reflective photoelectric switch 21 within this range not only helps reduce environmental interference to the reflective photoelectric switch 21, such as stray light, background light, or dust, thus improving the reliability of the encoder, but also ensures that the reflective photoelectric switch 21 can stably detect the code disk 22, thereby improving the accuracy of encoder detection.

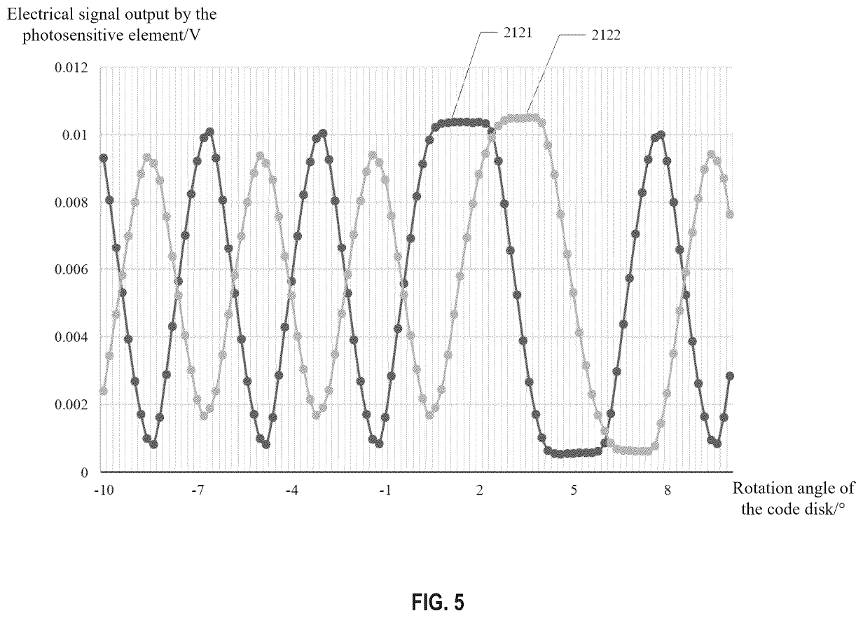

In an embodiment, as shown in FIG. 5, in the reflective photoelectric encoder 2, when the light-emitting element 211 and the photosensitive element 212 in the reflective photoelectric switch 21 are arranged sequentially along the radial direction perpendicular to the code disk 22, the electrical signal output by the reflective photoelectric switch 21 is 2121. When the light-emitting element 211 and the photosensitive element 212 in the reflective photoelectric switch 21 are arranged sequentially along the radial direction of the code disk 22, the electrical signal output by the reflective photoelectric switch 21 is 2122. Under the same conditions, changing only the placement position of the reflective photoelectric switch 21 relative to the code disk 22 can not only increase the amplitude of the useful signal, but also make the signal amplitudes corresponding to the first and second zones within the same circumference closer, resulting in a stronger and more consistent signal output by the reflective photoelectric switch 21, thereby making the motor control more stable.

In an embodiment, the code disk 22 is made of stainless steel. The first and second reflective areas on the code disk 22 are both made of mirror-finished stainless steel with a reflectivity exceeding 50% and a Gaussian scattering angle less than 10°. The first and second non-reflective areas are coated with a black metal, such as titanium, or with black ink using Physical Vapor Deposition. Because the mirror-like surfaces of the first and second reflective areas on the code disk 22 do not easily attract dust and oil, this helps maintain the cleanliness and reflectivity of the code disk 22, thereby ensuring the accuracy and stability of the encoder readings. The black metal coating on the first and second non-reflective areas of the code disk using Physical Vapor Deposition improves their wear resistance and corrosion resistance, ensuring the stability and high reliability of the encoder and extending its service life.

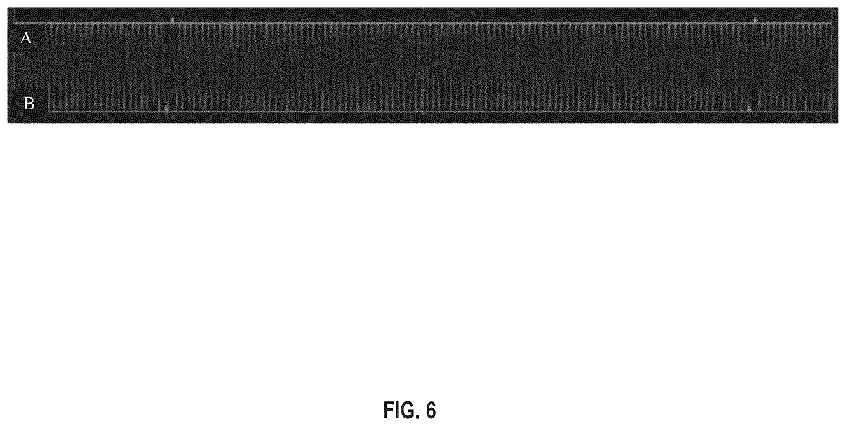

When the code disk 22 is manufactured using the aforementioned materials and processes, the corresponding output signal of the reflective photoelectric switch 21 is shown in FIG. 6. The signals output by the reflective photoelectric switch 21 in FIG. 6 exhibit good consistency; that is, not only are the output signal amplitudes at the same position on the code disk 22 consistent, but the amplitudes of the output signals corresponding to the first and second zones on the code disk 22 are also very close, thereby improving the reliability and stability of the encoder.

As shown in FIG. 3 and FIG. 6, the mirror-finished stainless steel material and the Physical Vapor Deposition process used in the code disk 22 of some embodiments in the present application, compared to the non-mirror-finished stainless steel material and electrophoresis process in other embodiments in the comparative example, result in a more stable and consistent signals output by the reflective photoelectric switch 21. The code disk 22 in some embodiments has a low manufacturing cost, can be mass-produced, and the corresponding reflective photoelectric switch 21 outputs more stable and reliable signals, thereby ensuring the stability of motor control.

In an embodiment, the code disk 22 of the reflective photoelectric encoder 2 includes multiple rings. The code disk 22 includes two concentric rings. Each ring surface includes a reflective area and a non-reflective area. The distribution of the reflective and non-reflective areas on the two rings can be designed in different ways to form different encoding patterns. The reflective photoelectric switch 21 is correspondingly configured to simultaneously cover the surfaces of these two rings. When the code disk 22 rotates, the reflective photoelectric switch 21 can detect signal changes on the surfaces of the two rings. These signals are ultimately converted into electrical signals to calculate the rotation angle and direction of the code disk 22. By increasing the number of rings on the code disk 22, on the one hand, the signal density is increased, thereby improving measurement accuracy and resolution. On the other hand, the measurement errors that may occur in a single ring can be reduced, thereby improving the overall signal quality and enhancing the stability and reliability of the encoder.

The above contents are only exemplary embodiments of the present application, and the protection scope of the present application is not limited thereto. Any technician familiar with the technical field can easily conceive changes or substitutions within the technical scope disclosed in the present application, which shall be included in the protection scope of the present application. Therefore, the protection scope of the present application shall be based on the claims.

What is claimed is:

1. A reflective photoelectric encoder, comprising a reflective photoelectric switch and a code disk, wherein:
a surface of the code disk includes a first zone and a second zone, the first zone includes a first reflective area and a first non-reflective area, and the second zone includes a second reflective area and a second non-reflective area;
in the first zone, an area between any two adjacent first non-reflective areas is the first reflective area, and a width of the first reflective area along a circumferential direction of the code disk is equal to a width of the first non-reflective area along a circumferential direction of the code disk;
the second reflective area and the second non-reflective area are adjacent to each other, and a width of the second reflective area along the circumferential direction of the code disk is equal to a width of the second non-reflective area along the circumferential direction of the code disk; and
the width of the second reflective area along the circumferential direction of the code disk is twice the width of the first reflective area along the circumferential direction of the code disk.

2. The reflective photoelectric encoder according to claim 1, wherein:
there are multiple first reflective areas and multiple first non-reflective areas; and
there is one second reflective area and one second non-reflective area.

3. The reflective photoelectric encoder according to claim 1, wherein:
the reflective photoelectric switch includes a light-emitting element, a photosensitive element, and a detection circuit; and
the light-emitting element and the photosensitive element are arranged sequentially along a radial direction perpendicular to the code disk.

4. The reflective photoelectric encoder according to claim 1, wherein:
the code disk is made of stainless steel; and
the first and second reflective areas are both made of mirror-finished stainless steel with a reflectivity of over 50% and a Gaussian scattering angle of less than 10°.

5. The reflective photoelectric encoder according to claim 1, wherein:
the first non-reflective area and the second non-reflective area are coated with black metal or ink; and
the first non-reflective area and the second non-reflective area are coated with black metal.

6. The reflective photoelectric encoder according to claim 3, wherein:
the reflective photoelectric switch further includes a housing, within which the light-emitting element, the photosensitive element and the detection circuit are all housed, and the housing is made of glass, ceramic, or aluminum.

7. The reflective photoelectric encoder according to claim 3, wherein:
the light-emitting element is a light-emitting diode, and the photosensitive element is a photodiode or a phototransistor.

8. The reflective photoelectric encoder according to claim 3, wherein:
the detection circuit includes a zero-crossing comparator configured to convert the received electrical signals into square wave signals, wherein the square wave signals are used to obtain position information of the code disk.

9. The reflective photoelectric encoder according to claim 3, wherein:
the detection circuit includes an analog-to-digital converter configured to convert the received electrical signals into digital signals, wherein the digital signals are processed to extract square wave signals, and the square wave signals are used to obtain position information of the code disk.

10. A LiDAR, comprising a reflective photoelectric encoder, wherein the reflective photoelectric encoder comprises a reflective photoelectric switch and a code disk, wherein:
a surface of the code disk includes a first zone and a second zone, the first zone includes a first reflective area and a first non-reflective area, and the second zone includes a second reflective area and a second non-reflective area;
in the first zone, an area between any two adjacent first non-reflective areas is the first reflective area, and a width of the first reflective area along a circumferential direction of the code disk is equal to a width of the first non-reflective area along a circumferential direction of the code disk;
the second reflective area and the second non-reflective area are adjacent to each other, and a width of the second reflective area along the circumferential direction of the code disk is equal to a width of the second non-reflective area along the circumferential direction of the code disk are equal; and
the width of the second reflective area along the circumference of the code disk is twice the width of the first reflective area along the circumference of the code disk.
